(19) United States
(12) Patent Application Publication
(10) Pub. No.: US 2022/0157045 A1
(43) Pub. Date: May 19, 2022

(54) AUTOMATIC EARLY-EXITING MACHINE LEARNING MODELS

(71) Applicant: QUALCOMM Incorporated, San Diego, CA (US)

(72) Inventors: Babak EHTESHAMI BEJNORDI, Amsterdam (NL); Amirhossein HABIBIAN, Amsterdam (NL); Fatih Murat PORIKLI, San Diego, CA (US); Amir GHODRATI, Amsterdam (NL)

(21) Appl. No.: 17/527,076

(22) Filed: Nov. 15, 2021

Related U.S. Application Data
(60) Provisional application No. 63/114,434, filed on Nov. 16, 2020.

(51) Int. Cl. G06V 10/764; G06V 10/80; G06V 10/82

(52) U.S. Cl. CPC G06V 10/764; G06V 10/82; G06V 10/811

(57) ABSTRACT

Certain aspects of the present disclosure provide techniques for processing with an auto exiting machine learning model architecture, including processing input data in a first portion of a classification model to generate first intermediate activation data; providing the first intermediate activation data to a first gate; making a determination by the first gate whether or not to exit processing by the classification model; and generating a classification result from one of a plurality of classifiers of the classification model.

### CROSS-REFERENCE TO RELATED APPLICATIONS

This application claims the benefit of and priority to U.S. Provisional Patent Application No. 63/114,434, filed on Nov. 16, 2020, the entire contents of which are incorporated herein by reference.

### INTRODUCTION

Aspects of the present disclosure relate to machine learning model architectures that include intermediate classifiers, which allow for automatic early exiting of the model to save computational resources.

Machine learning may generally produce a trained model (e.g., an artificial neural network, a tree, or other structures), which represents a generalized fit to a set of training data. Applying the trained model to new data produces “inferences,” which may be used to gain insights into the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically detecting features (e.g., faces) within images provided by a camera sensor of an electronic device.

However, conventional machine learning approaches must choose between larger, computationally-intensive models that perform well on a wide range of input data, and smaller, less computationally-intensive models that may perform well on simple input data, but not on complex input data. This tendency is engendered by model architectures that rely on the entire model to feed a single output layer, such as a classification layer. Because lower-power processing devices, such as mobile device, Internet of things (IoT) device, always-on devices, edge processing devices, smart wearable devices, and the like, may have inherent design limitations that limit on-board compute, memory, and power resources, such devices are often limited to deploying lower performance models.

Accordingly, what is needed are improved machine learning architectures that can provide the performance of larger models and the efficiency of smaller models in a single model architecture.

### BRIEF SUMMARY

Certain aspects provide a method for processing with an auto exiting machine learning model architecture, including processing input data in a first portion of a classification model to generate first intermediate activation data; providing the first intermediate activation data to a first gate; making a determination by the first gate whether or not to exit processing by the classification model; and generating a classification result from one of a plurality of classifiers of the classification model.

Further aspects provide a method of performing classification with a classification model, wherein: the classification model comprises: a feature extraction component; a feature aggregating component; a plurality of gates; and a plurality of classifiers, wherein each gate of the plurality of gates is associated with one classifier of the plurality of classifiers, and the method comprises: extracting a clip from an input video; sampling the clip to generate a plurality of video frames; providing a first video frame of the plurality of video frames to the feature extraction component to generate a first feature map; providing the first feature map to a first gate of the plurality of gates; making a determination by the first gate whether or not to exit processing by the classification model based on the first feature map; and generating a classification result from one of the plurality of classifiers of the classification model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts a machine learning model architecture for automatic early exiting.

FIG. 2 depicts an example gate that may be used with a machine learning model architecture for automatic early exiting.

FIG. 3 depicts an example gate model that may be used with a machine learning model architecture for automatic early exiting.

FIG. 4 depicts another example of a gate that includes multiple gate models.

FIG. 5 depicts an example model architecture for efficient video recognition.

FIG. 6 depicts an example gate model that may be implemented for efficient video recognition.

FIG. 7 depicts an example method for performing processing with an early exiting model architecture, such as described with respect to FIGS. 1-4.

FIG. 8 depicts an example method for performing processing with an early exiting model architecture, such as described with respect to FIGS. 5-6.

FIG. 9 depicts an example processing system that may be configured to perform the methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for machine learning model architectures that include intermediate classifiers, which allow for automatic early exiting of the model to save computational resources.

Aspects described herein may generally be composed of a cascade of intermediate classifiers such that “easier” (e.g., less complex) input data are handled using earlier and thus fewer classifiers, and “harder” (e.g., more complex) input data are handled using later and thus more classifiers. Gating logic associated with each of the intermediate classifiers may be trained to allow such models to automatically determine the earliest point in processing where an inference is sufficiently reliable, and to then bypass additional processing.

Because a significant percentage of classification in such models may be able to “early exit” to an intermediate classifier before a final model classifier, such models use significantly fewer computational resources on average, which beneficially opens such models up to deployment on many different types of devices, such as the lower power processing devices described above. The model architectures described herein may be useful for many different applications, such as classifying, indexing, and summarizing image and video data, estimating human pose in image or video data, surveillance object detection, anomaly detection, autonomous driving (e.g., recognizing objects, signs, obstructions, road markings), user verification, and others.

### Machine Learning Model Architecture for Automatic Early Exiting

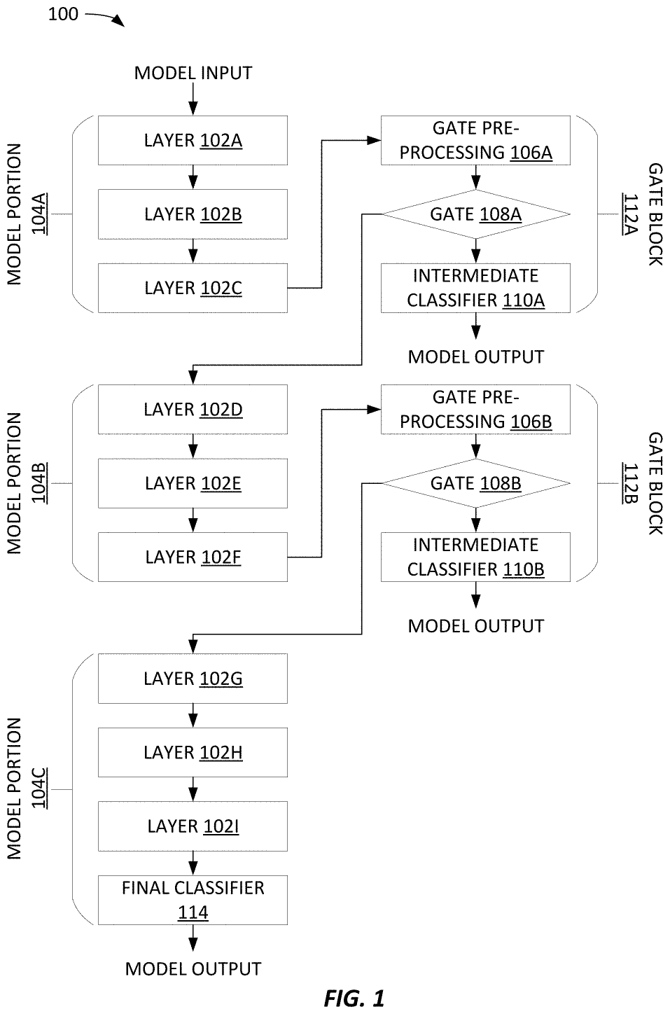

FIG. 1 depicts a machine learning model architecture 100 for automatic early exiting.

In the depicted example, model architecture 100 includes model portions 104A-C, which each includes a plurality of layers (e.g., 102A-C in model portion 104A, 102D-F in model portion 104B, and 102G-I in model portion 104C), which may be various sorts of layers or blocks of a machine learning model, such as a deep neural network model. For example, the individual layers 102A-I may include convolutional neural network layers, such as pointwise and depthwise convolutional neural network layers, pooling layers, recurrent layers, residual layers, fully connected (dense) layers, normalization layers, and the like. Collectively, model portions 104A-C may be referred to as a primary or backbone model.

Conventionally, a neural network model may be processed from model input at layer 102A to model output at final classifier 114. Unlike conventional models, model architecture 100 includes gate (or gating) blocks 112A-B. Generally, gate blocks 112A-B allow for model architecture 100 to automatically determine whether an “early exit” is possible from the model based on some input data, such that only a portion of the model needs to be processed. When an early exit is possible, significant time and processing resources, such as compute, memory, and power use, are saved. In this example, there are three model portions 104A-C interleaved with two gate blocks 112A-B, but any number of model portions and gate portions may be implemented in other examples, Further any number of layers or other model processing blocks may constitute a model portion.

In the depicted aspect, each gate block (112A and 112B) includes a gate pre-processing component (layer or block) (106A and 106B), a gate (108A and 108B), and an intermediate classification layer (classifier) (110A and 110B).

Gate pre-processing components 106A-B may each include one or more sub-layers or elements, which may be configured to prepare intermediate model data, such as intermediate activation data, feature maps, and the like, for processing by gates 108A and 108B, respectively. For example, gate pre-processing components 106A-B may comprise one or more convolutional layers, reshaping layers, downsampling layers, and the like trained to elicit features useful for the gates 108A-B to make gating decisions. Note that gate pre-processing components 106A-B are optional, and may be omitted in other aspects.

Gates 108A-B are generally configured to process intermediate model data and determine whether an early exit is appropriate.

If a gate determines that an early exit is not appropriate, then processing returns to the next model portion. For example, if gate 108A determines that an early exit is not appropriate, then model processing returns to model portion 104B, and in particular to layer 102D in this example. In this example, the data provided to layer 102D is the same intermediate model data provided to gate pre-processing component 106A, rather than the data generated by gate pre-processing components 106A. In some aspects, a gate, such as 108A, simply causes the next layer in the primary model (102D in this example) to retrieve the data from a commonly accessible memory (not depicted in FIG. 1), such as an activation buffer or the like in a host processing system.

If, on the other hand, a gate determines that an early exit is appropriate, then the intermediate model data is provided to an intermediate classifier to generate model output and thereafter the model is exited. For example, if gate 108A determines that an early exit is appropriate, then the output of gate pre-processing block 106A is provided to intermediate classifier 110A to generate model output. In other words, in this example, the input for a gate (e.g., 108A) is the same as the input to the intermediate classifier associated with that gate (e.g., 110A). Gates 108A-B thus act as binary decision elements in model architecture 100, which generate an early exit or continue processing decision.

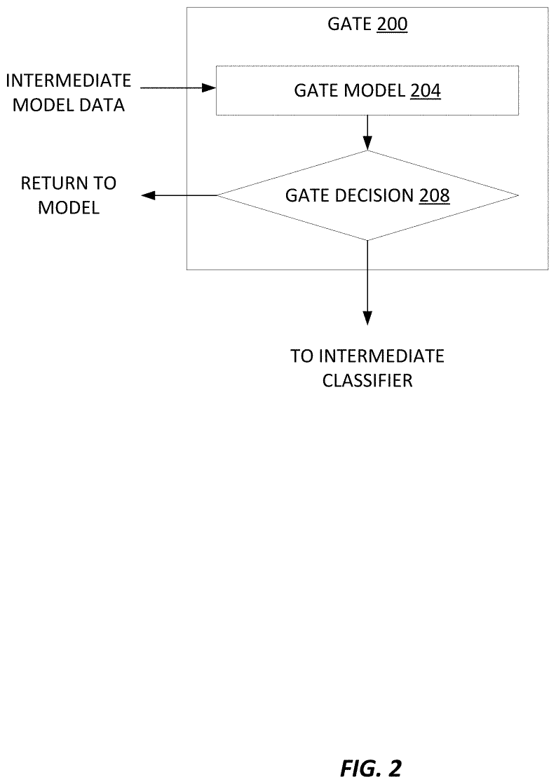

Examples of gates 108A and 108B are described in more detail with respect to FIGS. 2-4.

In the event that no gate (e.g., 108A or 108B in this example) determines that an early exit is appropriate, then model architecture 100 will ultimately conclude with final classifier 114 providing the model output.

Generally, classifiers 110A, 110B, and 114 may be configured to take model data (e.g., feature maps, activation data, and the like) and generate model output, such as classifications in some aspects. For example, model input of image data may generate model output of classifications of objects found in the image data, characteristics of those objects, and the like. Similarly, model input of video data may generate model output of classifications of objects found in the video data, characteristics of those objects, and the like. As yet another example, model input of audio data may generate model output of classification of audio structures, sounds, or the like found in the audio data. In some cases, image, video, and/or audio input data may be used for verification (as a model output), such as for user verification. Notably, these are just some types of model inputs and outputs, and many others are possible. For example, other input data, such as from other types of sensors, may be used to generate other types of outputs.

### Example Gate Architecture

FIG. 2 depicts an example gate (or gate component) 200, which is an example of a type of gate that may be used for gates 108A and 108B in FIG. 1.

In the depicted example, gate 200 includes a gate model 204 and a gate decision element 208. Gate model 204 generally receives intermediate model data (which may or may not have been pre-processed, as described above) and processes the intermediate model data to determine whether an early exit is appropriate.

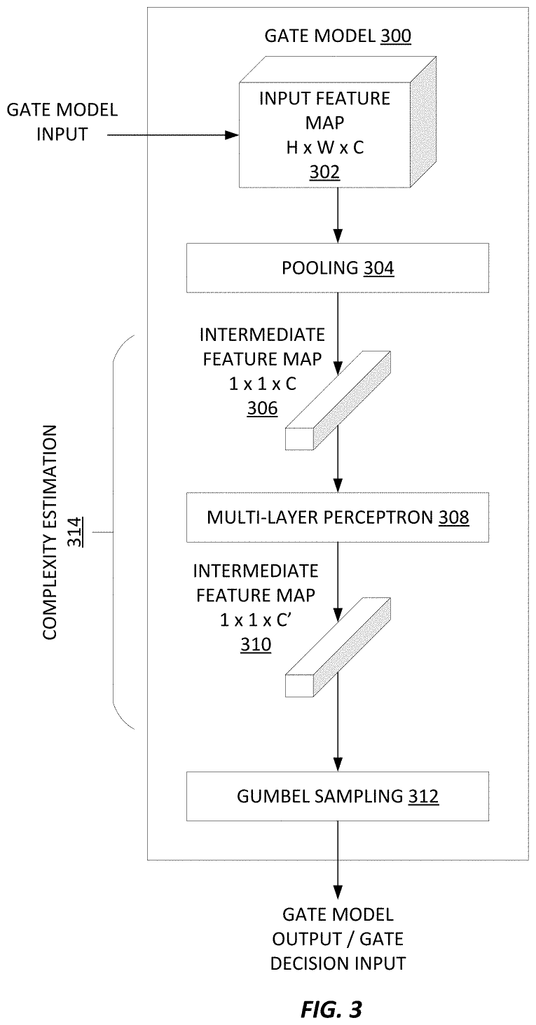

For example, gate model 204 may be trained to infer the complexity and/or difficulty of the intermediate model data for an associated intermediate classifier (e.g., intermediate classifier 110A for gate 108A). The inferred complexity of the intermediate model data may be used by gate decision element 208 to decide to process the intermediate model data with the associated intermediate classifier. An example gate model is described further with respect to FIG. 3.

In some aspects, gate decision element 208 may be a threshold comparator configured to compare an output of gate model 204 to a decision threshold. For example, the output of gate model 204 may be a probability or confidence that an intermediate classifier can correctly classify the intermediate model data, and if that confidence exceeds the decision threshold, processing of the intermediate model data is performed by the intermediate classifier, and if not, then the intermediate model data is sent back to the primary model for further processing.

### Training Gates for Concurrent Objectives of Model Accuracy and Processing Sparsity

During training, gates may naturally learn to postpone exiting so that the last (or deepest) classifier always generates the model output (e.g., final classifier 114 in FIG. 1) because that may tend to maximize accuracy at the expense of additional processing. However, this sort of training result largely defeats the purpose of the early exiting architecture depicted in FIG. 1.

Accordingly, gate models (e.g., 204) may be trained to maximize concurrent objectives (subject to tradeoff parameters) of model accuracy and processing sparsity, where sparsity is increased by exiting earlier from a model, and reduced by exiting later.

FIG. 3 depicts an example gate model 300, which may be used in a gate, such as gates 108A-B in FIG. 1 and gate 200 in FIG. 2 (e.g., for gate model 204).

Initially, gate model input data is provided to gate model 300 as an input feature map 302. The input feature map is pooled in pooling layer 304 to generate an intermediate feature map 306.

Next, intermediate feature map 306 is processed in a complexity estimation portion 314 of gate model 300, which in this example includes a multi-layer perceptron 308. In some aspects, multi-layer perceptron 308 may include two layers. Generally, the complexity estimation portion is configured to estimate the complexity of the gate model input.

The output of multi-layer perceptron 308 is another intermediate feature map 310, which is then processed by a straight-through Gumbel sampling component 312. The straight-through Gumbel sampling component 312 is configured to determine whether to early exit the model or to continue processing in the primary model based on the estimate or value generated by the complexity estimation portion 314. In some aspects, gate model output may be a vector of size 1×1×C′, where C′ is the number of decisions for the gate to make. In the case of a binary decision gate, such as “exit” or “continue processing”, C′=2 if a Gumbel Softmax layer is used, or C′=1 if a Gumbel Sigmoid layer is used. Other configurations are possible.

Beneficially, gate model 300 may be trained to make decisions on when a model architecture (such as 100 in FIG. 1) can early exit without impacting the accuracy of the model output. In this example, complexity estimation portion 314 takes as input simple statistics of the gate model input, which may be a feature map such as 302. These simple statistics are, for example, the average over the spatial dimensions of input feature map 302, which may be generated by pooling layer 304 in this example to generate intermediate feature map 306, which has dimensions 1×1×C. Gating model 300 may generally be configured to make a binary decision at the forward path, such as zero (0) for early exit and one (1) for continue processing (or vice versa).

Notably, during backpropagation through the backward path of gate model 300, the discrete decision of gate model 300 may be modeled with a continuous representation. For example, the Gumbel sampling 312 may be used to approximate the discrete output of gate model 300 with a continuous representation, and to allow for the propagation of gradients back through gate model 300. This allows gate model 300 to make discrete decisions and still provide gradients for the complexity estimation, which in turn allows gate model 300 to learn how to decide whether to early exit or not based on the complexity of the gate model input (e.g., image data, sound data, and video data).

In the example of Gumbel Softmax sampling, let u˜Uniform (0,1). A random variable G is distributed according to a Gumbel distribution G˜Gumbel (G; μ, β), if G=μ−β ln(−ln(u)). The case where μ=0 and β=1 is called the standard Gumbel distribution. Using the Gumbel-Max trick allows drawing samples from a Categorical(π₁ . . . πᵢ) distribution by independently perturbing the log-probabilities πᵢ with independent and identically distributed Gumbel(G; 0; 1) samples and then computing the argmax. That is:

arg maxᵢ[ln πᵢ+Gᵢ]˜Categorical(π₁ . . . πᵢ)

In some aspects, Gumbel sampling 312 may sample from a Bernoulli distribution Z˜B(z; it), where π₁ and π₂=1−π₁ represent the two states for each of gate, e.g., early exit or continue processing. Letting z=1 means that:

ln π₁+G₁>ln(1−π₁)+G2.

Provided that the difference of two Gumbel-distributed random variables has a logistic distribution G₁−G₂=ln(u)−ln(1−u), the argmax operation in the equation above yields:

$$z = \{ \begin{matrix}1 & ln ( u ) - ln ( 1 - u ) + ln {π}_{1} - ln ( 1 - {π}_{1} ) > 0 & \\ 0 & Otherwise & \end{matrix}$$

The argmax operation is non-differentiable, but the argmax may be replaced with a soft thresholding operation such as the sigmoid function with temperature: σ_{τ}(x)=σ

$$( \frac{x}{τ} ) .$$

The parameter τ controls the steepness of the function. For τ→0, the sigmoid function recovers the step function. In some aspects, τ=⅔.

The Gumbel-Max trick, therefore, allows the gate mode 300 to back-propagate the gradients through the primary model (e.g., model architecture 100 in FIG. 1).

During training, it is possible for gate models to “collapse” to either being completely on, or completely off, or alternatively, to make random decisions without learning to make a decision conditioned on the input. The preferred function of gate model 300 is for its output to be conditioned on its input. To accomplish this, gate model 300 may be configured to back propagate a loss function, such as:

$${ }^{Loss} CDF = \frac{1}{N} {\sum }_{i = 0}^{N} {( \frac{i}{N} - CDF ( sort ( {x}_{i} ) ) )}^{2} , \qquad ( 1 )$$

in which N is batch size of the feature maps. The loss function of Equation 1 may be referred to as a batch-shaping loss. Back propagating this loss function may be referred to generally as Batch-wise conditional regularization. Batch-wise conditional regularization may match the batch-wise statistics for each gate model (e.g., 300) to a prior distribution, such as a prior beta-distribution probability density function (PDF). This ensures that for a batch of samples, the regularization term pushes the output to the on state for some samples, and to the off state for the other samples, while also pushing the decision between the on/off states to be more distinct. Batch-wise conditional regularization may generally improve conditional gating, such as used in model architecture 100 of FIG. 1.

In order to facilitate learning of more conditional features, gate model 300 may be configured to introduce a differentiable loss that encourages features to become more conditional based on batch-wise statistics. The procedure defined below may be used to match any batch-wise statistic to an intended probability function.

Consider a parameterized feature in a neural network X(θ), the intention is to have X(θ) distributed more like a chosen probability density function f_{X}(x), defined on the finite range [0, 1] for simplicity. F_{X}(x) is the corresponding cumulative distribution function (CDF). To do this, gate model 300 may consider batches of N samples x₁:N drawn from X(θ). These may be calculated during training from the normal training batches. Gate model 300 may then sort x₁:N. If sort(x_{1:N}) was sampled from f_{X}(x), then gate model 300 would have that

$$E [ {F}_{X} ( sort ( {x}_{i} ) ) ] = \frac{i}{N}$$

for each i i∈1: N. Gate model 300 may average the sum of squared differences for each F_{X}(sort(xᵢ))] and their expectation

$$\frac{i}{N}$$

to regularize X(θ) to be closer to f_{X}(x).

Summing for each considered feature gives the overall batch-shaping loss, as above in Equation 1. Note that the gate model 300 may differentiate through the sorting operator by keeping the sorted indices and undoing the sorting operation for the calculated errors in the backward pass. This makes the whole loss term differentiable as long as the CDF function is differentiable.

Gate model 300 may use this batch-shaping loss to match a feature to any PDF. For example, gate model 300 may implement the batch-shaping loss with a Beta distribution as a prior. The CDF Iₓ (a, b) for the Beta distribution may be defined as:

$$B ( x ; a , b ) = {\int }_{0}^{x} {{t}^{a - 1} ( 1 - t )}^{b - 1} dt , and {I}_{x} ( a , b ) = \frac{B ( x ; a , b )}{B ( a , b )} .$$

In at least one example, Gate model 300 may be implemented with a=0.6 and b=0.4. The Beta-distribution may regularize gates towards being either completely on, or completely off. Moreover, this batch-shaping loss may encourage gate model 300 to learn more conditional features.

Large model architectures may become highly over-parameterized, which may lead to unnecessary computation and resource use. In addition, such models may easily overfit and memorize patterns in the training data, and could be unable to generalize to unseen data. This overfitting may be mitigated through regularization techniques.

L₀ norm regularization is one approach that penalizes parameters for being different than zero without inducing shrinkage on the actual values of the parameters. An L₀ minimization process for neural network sparsification may be implemented by learning a set of gates that collectively determine weights that could be set to zero. Gate model 300 may implement this approach to sparsify the output of the gate by adding the following complexity loss term:

$${L}_{C} = λ {\sum }_{i = 0}^{k} σ ( ln {π}_{i} )$$

where k is the total number of gates, σ is the sigmoid function, and λ is a parameter that controls the level of sparsification gate model 300 is configured to achieve.

### Example Multi-Objective Gate

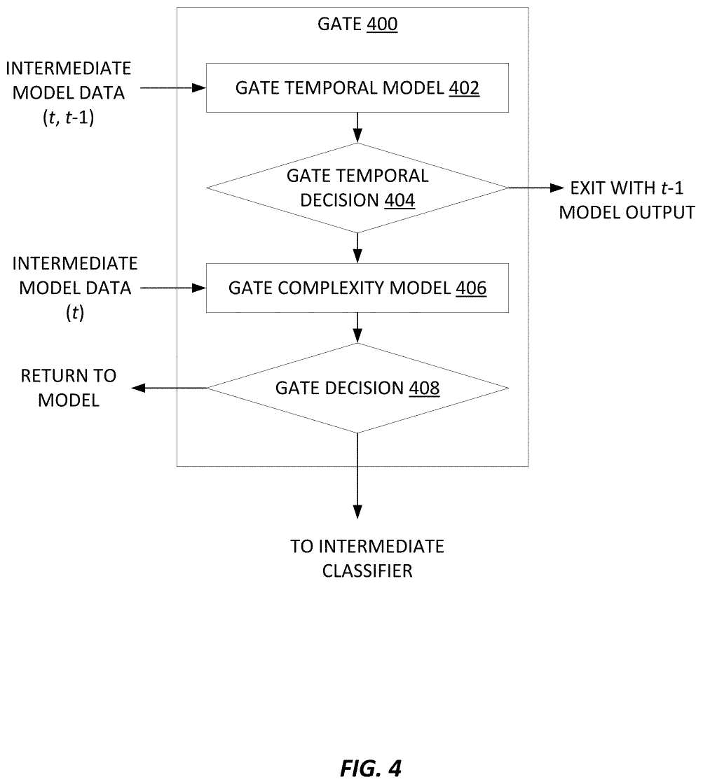

FIG. 4 depicts another example of a gate 400 that includes multiple gate models configured to perform gating based on different objectives. Gate 400 may be useful for serial data, such as time series data, video data, audio data, and the like. In some aspects, gate 400 may be used for gates 108A-B in FIG. 1 and gate 200 in FIG. 2.

In this example, gate 400 includes a gate temporal model 402 that is configured to compare multiple instances of serial intermediate model data. For example, in the context of video data, gate temporal model 402 may compare video data (e.g., a frame) from a current time step t and a preceding time step t−1 (or any other offset) to determine their similarity. In one aspect, gate temporal model 402 may perform a pixel-by-pixel or pixel-pattern comparison of two video frames to determine the difference between the current and proceeding intermediate model data.

If the similarity of the current time step data and the preceding time step data is above a threshold (or the dissimilarity is below a threshold) as determined by gate temporal model 402, then gate temporal decision element 404 may choose to exit with the model output from time step t−1 based on the notion that very similar input should result in the same output.

In some aspects, the model output from the preceding time step may be stored in a memory and provided as model output upon the decision by gate temporal decision element 404 to exit.

If the similarity of the current time step data and the preceding time step data is below a threshold (or the dissimilarity is above a threshold) as determined by gate temporal model 402, then gate temporal decision element 404 may choose to continue processing with gate complexity model 406.

In the depicted example, gate complexity model 406 uses intermediate model data for the current time step t. Gate complexity model 406 may be implemented as described with respect to gate model 300 in FIG. 3.

The output of gate complexity model 406 is used by gate decision element 408 to make a decision as to whether to return to the primary model for further processing or to early exit to an intermediate classifier.

### Machine Learning Model Architecture for Efficient Video Recognition

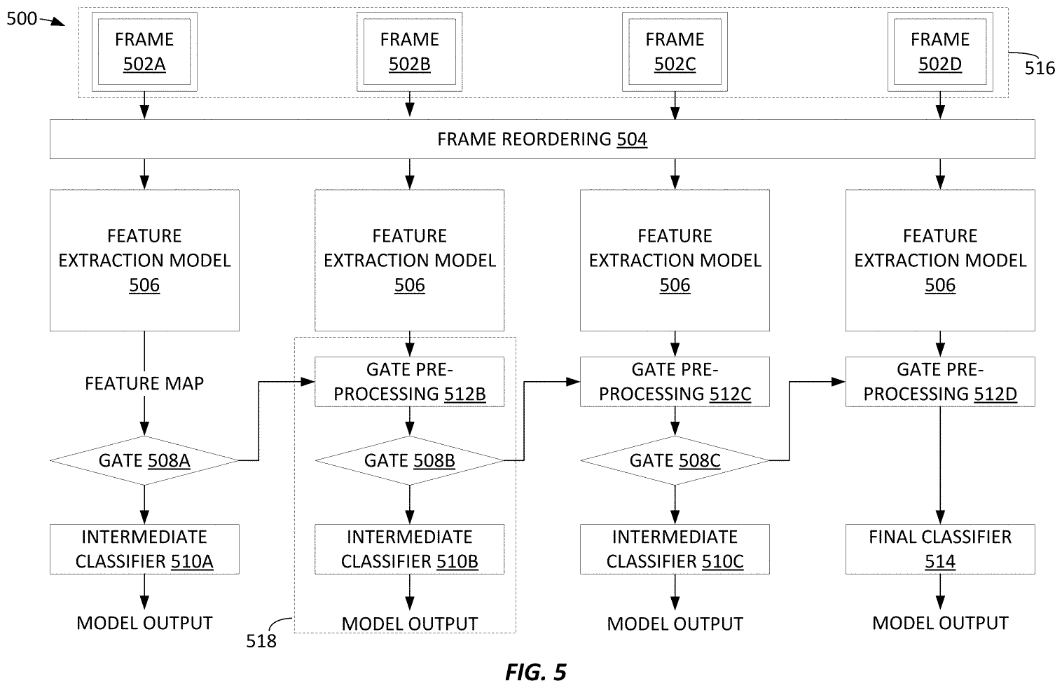

FIG. 5 depicts an example model architecture 500 for efficient video recognition using early exiting.

Current state-of-the-art models for the task of action recognition in video data offer promising results, but they are computationally expensive as they need to be applied on densely sampled frames during inferencing. To address this issue, current approaches invoke the model on a subset of frames that is obtained from sampler modules that are parametrized with another deep neural network model. In contrast, model architecture 500 does not need a complicated and computationally costly sampling mechanism. Rather, model architecture 500 uses an efficient sampling policy and automatic exiting, as described herein, to stop processing automatically and thereby to save significant computational resources. Like model architecture 100, model architecture 500 is accurate and efficient.

Model architecture 500 includes a feature extraction model 506, which is common to a plurality of gate blocks, such as gate block 518. Note that certain aspects of model architecture 500 are repeated in FIG. 5 for process flow clarity, such as feature extraction model 506, but there need not be multiple instances of feature extraction model 506 in practice. Similarly, individual gate pre-processing blocks are included for certain gate blocks, but in practice a single gate pre-processing block could be shared by multiple gate blocks.

As with the gate blocks in FIG. 1 (e.g., 112A-B), gate blocks in model architecture 500 (e.g., 518) include gate pre-processing components 512, gates 508A-C, and classifiers 510A-D. However, in model architecture 500, gate pre-processing components 512B-D include temporally distinct inputs, including the feature extraction model 506 output for a current video frame (e.g., one of 502A-D) as well as the feature extraction model output for a previously processed frame (e.g., another one of 502A-D). In some aspects, gate pre-processing components 512B-D may be configured to perform a pooling operation (e.g., max pooling) on the feature maps produced by feature extraction model 506 for the two different frames and provide the pooled output as one of two inputs to a gate block.

Note that gate 508A does not include two temporally separate inputs (e.g., inputs from two different frames) because it processes the first frame, and thus there is no preceding frame. As such, the input to gate 508A is directly from feature extraction model 506 as compared to the gate pre-processing components 512 that provide one of the inputs to gates 508B-C. In practice, a similar gate block may be used for all gates, and the pre-processing component may just be bypassed for the first frame. Here again, FIG. 5 is meant to depict a process flow.

As explained in more detail below with regard to the frame sampling policy, it is notable that the features map outputs associated with the current frame and preceding frame need not be from temporally adjacent frames in the original video clip (e.g., 516) from which they are sampled. Rather, as below, a reordered set of frames may be provided via frame reordering component 504. In some aspects, the reordering is performed according to a frame sampling policy, which is described in more detail below.

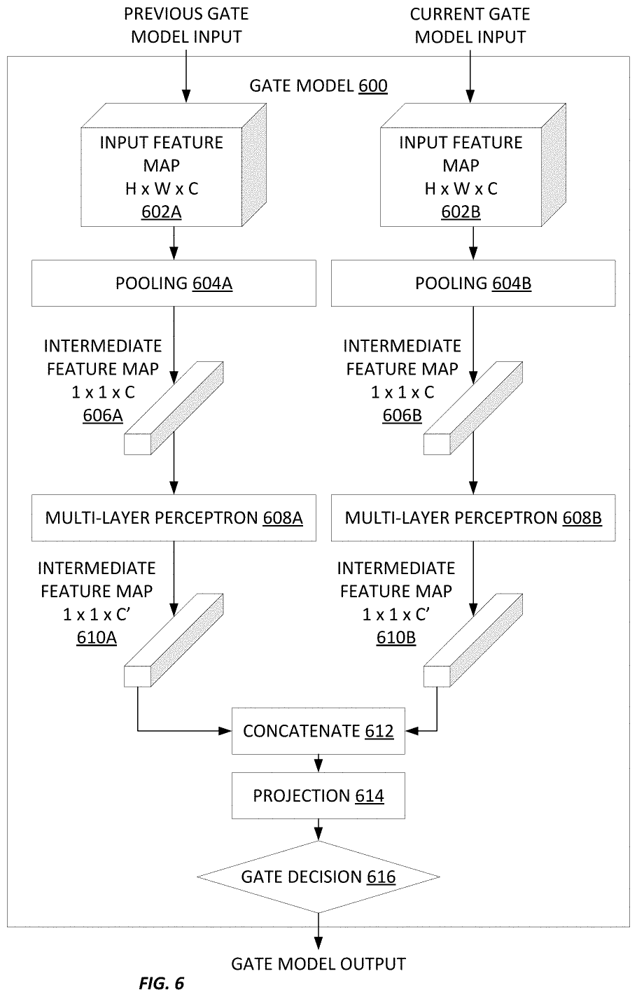

An example of a gate model that may be implemented by gates 508A-C is described below with respect to FIG. 6.

The general process flow as depicted in FIG. 5 is that a clip 516 may be generated from a video stream, which includes multiple individual frames 502A-D. The frames 502A-D of clip 516 are reordered (e.g., shuffled) according to a sampling policy and then provided sequentially (according to the reordering) to feature extraction model 506. An example of a sampling policy is described in more detail below.

The first frame provided to feature extraction model 506 will necessarily not have a preceding frame, so the output from feature extraction model 506 (e.g., a feature map) is provided directly to a gate, which in this example is gate 508A. Gate 508A decides whether its associated intermediate classifier 510A should process the frame, which represents an early exit from processing the entire clip 516, or whether model architecture 500 should continue processing additional frame data.

If gate 508A decides to early exit, then the feature map is provided to intermediate classifier 510A, which generates model output, such as a classification of objects in the clip 516 based on the frame that has been processed.

If gate 508A decides to continue processing, then model architecture 500 processes another frame with feature extraction model 506 to generate a second, “current” feature map, which may be also considered a partial clip representation. Note as above that the second feature map may actually be a frame from earlier in clip 516 due to the frame reordering by component 504.

The feature map for the current frame as well as the feature map for the preceding frame are provided as inputs to gate pre-processing component 512B, which may aggregate the features together, such as by a pooling operation. The aggregated feature map and the feature map for the previously processed frame are then provided to gate 508B for another early exit determination.

As before, if gate 508B decides to early exit, then the aggregated feature map is provided to intermediate classifier 510B, which produces model output. If gate 508B decides not to early exit, then the same process is repeated with the next frame and gate 508C. Notably, with each additional frame, more features are aggregated for the next gate.

If, in this example, gates 508A-C all decide upon continued processing, then eventually a model output is generated by final classifier 514.

### Generalized Formulation of Early Exiting Video Recognition Model Architecture

Given a video as an input, at each time step t, a frame is sampled from the video based on a deterministic policy function, which is described below in more detail. Note that the time step t may be different from the underlying frames per second (FPS) of the video input. Each frame is independently represented by the feature extraction model 506 and is aggregated to features of previous time steps using accumulated feature pooling, such as may be performed by gate pre-processing blocks 512B-D (generally 512). In other words, starting from a single frame, incrementally more temporal details are added at each time step t until a gate function Gₜ (as implemented by gates 508A-C, for example) decides to exit, or until the final classifier is reached.

Given a set of videos and their labels {vᵢ, yᵢ}ᵢ₌₁^{D}, the aim of model architecture 500 is to classify each video by processing the minimum number of frames, which beneficially saves significant processing power, processing time, memory use, etc. Generally, model architecture 500 may implement (1) a frame sampling policy π, (2) a feature extraction model Φ (e.g., 506), an accumulated feature pooling function (e.g., as implemented by gate pre-processing blocks 512B-D), and (4) T classifiers fₜ (e.g., classifiers 510A-C and 514) and associated exiting gates gₜ (e.g., 508A-C), where T is the number of input frames.

Given an input video, a partial clip x_{1:t} may be extracted by incrementally sampling t frames from the video based on a sampling policy ii:

x_{1:t}=[x_{1:t-1};xₜ],t˜π(·), (2)

where x_{1:t-1} denotes a partial clip of length t−1 and xᵢ is a single video frame. Each frame xᵢ is independently represented by the feature extraction model Φ (e.g., 506). These representations are then aggregated using accumulated feature pooling (e.g., by gate pre-processing blocks 512). The resulting clip level representation, zₜ, is then passed to the classifier fₜ and its associated early exiting gate gₜ.

Starting from a single-frame clip, temporal details are incrementally added at each time step until one of the gates generates an exit signal. In the example of FIG. 5, each gate 508 may be implanted as a binary function gₜ: (zₜ₋₁, zₜ)→{0,1} indicating whether the model has reached a desired confidence level to exit. More specifically, the final video label will be generated as:

y=fₜ(zₜ),if gₜ(zₜ₋₁,zₜ)=1, (3)

where t represents the time step associated with the earliest frame, sampled according to the policy π, that meets the gating condition.

### Example Frame Sampling Policy

In one aspect, a policy function receives a video of N frames, and samples T frames (T<<N) using the policy function π(v). For example, in FIG. 5, this policy function may be implemented by frame reordering component 504. While π is generally parameterized with a light-weight model and trained using policy gradient methods or Gumbel reparametrization in conventional approaches, aspects described herein use a deterministic and parameter-free function instead. The function described herein performs as well as sophisticated frame selection models without the need for the additional training and complexity costs of a frame selection model.

Generally, the sampling function π follows a coarse-to-fine principle for sampling in a temporal dimension. It starts sampling from a coarse temporal scale and gradually adds finer details to the temporal structure. In some aspects, the first frame may be sampled from the middle of the video, then subsequent frames may be repeatedly sampled from the two halves of the video (i.e., on either side of the first frame that is sampled). Compared to sequential sampling, this strategy allows the feature extraction model (e.g., 506) to have access to a broader time horizon at each timestamp while mimicking the behavior of reinforcement learning approaches that jump forward and backward to seek future informative frames and re-examine past information.

### Example Feature Extraction Model

Feature extraction model 506 may generally be represented as Φ(xᵢ;θ_{Φ}), which in some aspects is a 2D image representation model, parametrized by θ_{Φ}, that extracts features for input frame xᵢ. ResNet-50 and EfficientNet-b3 are examples of feature extraction models that may be used in aspects described herein.

### Accumulated Feature Pooling

Feature pooling beneficially allows for efficiently representing a multi-frame clip, up to and including the entire clip x_{1:t}. To limit the computation costs to only the newly sampled frame, the clip representation is incrementally updated. Specifically, given the sampled frame xₜ and features zₜ₋₁, a video clip may be represented as:

zₜ=Ψ(xₜ₋₁;Φ(xᵢ;θ_{Φ})), (4)

where Ψ is a temporal aggregation function that can be implemented by statistical pooling methods, such as average or max pooling, long short term memory (LSTM) models, or self-attention models, to name a few possibilities.

### Early Exiting

While processing the entire frames of a video is computationally expensive, processing a single frame may also restrict a model's ability to recognize an action in the video. Accordingly, model architecture 500 is implemented as a conditional early exiting model with T classifiers accompanied by their associated early exiting gates that are attached at different time steps to allow early exiting. Each classifier fₜ receives the clip representation zₜ as input and makes a prediction about the label of the video. During training, the parameters of the feature extraction model and the classifiers are optimized using the following loss function:

$${ℒ}_{cls} = \frac{1}{T} {\sum }_{t = 0}^{t = T} {ℓ}_{cls} ( {f}_{t} ( {z}_{t} ; {θ}_{f} ) , y ) \qquad ( 5 )$$

In some aspects, the standard cross-entropy loss is used for single-label video datasets and binary cross-entropy loss is used for multi-label video datasets.

Each gate gₜ (e.g., 508A-C) may be parameterized as a multi-layer perceptron, predicting whether the partially observed clip x_{1:t} is sufficient to accurately classify the entire video. Beneficially, the exiting gates have a very light design to avoid any significant computational overhead.

Generally, each gate gₜ(zₜ₋₁,zₜ)→{0,1} receives as input the aggregated representations zₜ and zₜ₋₁ (e.g., via the two inputs to each gate pre-processing block 512). In some aspects, each of these representations are first passed to two layers of multi-layer perceptron with a plurality of neurons a piece (e.g., 64 neurons per multi-layer perceptron). Note that in some aspects, each gate model shares weights. The resulting features are then concatenated and linearly projected and fed to a sigmoid function. The parameters of the gates θ_{g} are learned in a self-supervised way by minimizing the binary cross-entropy between the predicted gating output and pseudo labels yₜ^{g}:

$${ℒ}_{gate} = \frac{1}{T} {\sum }_{t = 0}^{t = T} BCE ( {ℊ}_{t} ( {z}_{t - 1} , {z}_{t} ; {θ}_{ℊ} ) , {y}_{t}^{ℊ} ) . \qquad ( 6 )$$

In some aspect, pseudo labels may be defined for a gate gₜ based on the classification loss according to:

$${y}_{t}^{g} \{ \begin{matrix}0 & {ℓ}_{cls} ( {f}_{t} ( {z}_{t} ) , y ) \leq {ϵ}_{t} \\ 1 & else\end{matrix} , \qquad ( 7 )$$

where ϵₜ determines the minimum loss required to exit through fₜ. Provided that the early stage classifiers observe very limited number of frames, it may be desirable to only enable exiting when the classifier is highly confident about the prediction, e.g., when fₜ has a low loss. Hence, it may be preferred to use smaller ϵₜ for these classifiers. On the other hand, late stage classifiers mostly deal with difficult videos with high loss. Therefore, when proceeding to later stage classifiers, ϵₜ may be increased to enable early exiting. In some aspects,

$${ϵ}_{t} = βexp ( \frac{t}{2} ) ,$$

where β is a hyper-parameter that controls the trade-off between model accuracy and total computation costs. The higher the β, the more computational saving may be obtained.

In one aspect, the final objective for training an early exiting video recognition model, such as in FIG. 5, is given as:

[symbol]

= [symbol] _{(v,y)˜D}_{ₜᵣₐᵢₙ}[ [symbol] _{cls}+ [symbol] _{gate}] (8)

Note that in Equation 7, equal weights are used for the classification and gating loss terms, but in other aspects, a weighting parameter may be used to bias the loss function in either direction.

### Example Gate Model

FIG. 6 depicts an example gate model 600 that has an efficient design, which beneficially reduces computational overhead. It receives as input the aggregated representations from the current frame and the previous frame (e.g., input feature maps 602A and 602B, respectively).

In gate model 600, the input feature maps 602A and 602B are pooled by pooling components 604A and 604B thereby generating intermediate feature maps 606A and 606B. These intermediate feature maps are then passed to multi-layer perceptrons 608A and 608B independently, which in this example share weights and have two layers. The resulting intermediate feature maps 610A and 610B are then concatenated by a concatenation component 612 and linearly projected by a linear projection component 614, the output of which is fed to gate decision component 616, which may implement, for example, a Gumbel Softmax with the two possible outcomes described above. This method may be referred to as a late-fusion method.

### Example Methods of Processing with an Early Exiting Model Architecture

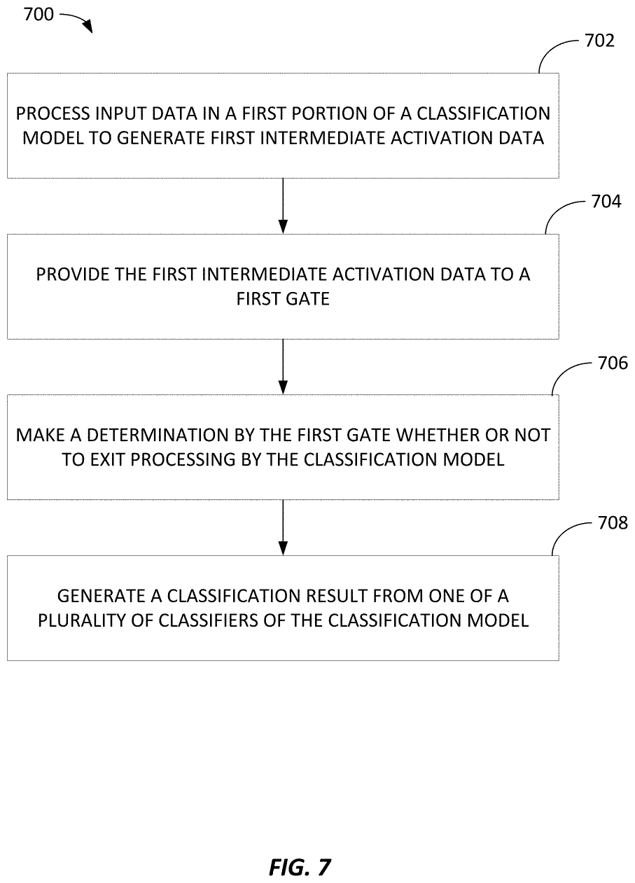

FIG. 7 depicts an example method for performing processing with an early exiting model architecture, such as that described above with respect to FIGS. 1-4.

Method 700 begins at step 702 with processing input data in a first portion of a classification model to generate first intermediate activation data.

Method 700 then proceeds to step 704 with providing the first intermediate activation data to a first gate.

In some aspects of method 700, the first gate comprises: a pooling layer configured to reduce a dimensionality of the first intermediate activation data; one or more neural network layers configured to generate the determination of whether or not to exit processing by the classification model; and a Gumbel sampling component, such as depicted and described with respect to FIG. 3.

In some aspects of method 700, the one or more neural network layers comprise a plurality of multi-layer perceptron layers.

Method 700 then proceeds to step 706 with making a determination by the first gate whether or not to exit processing by the classification model.

In some aspects of method 700, the first gate has been trained using a batch-shaping loss function to minimize classification error and to minimize processing resource usage.

In some aspects of method 700, the determination by the first gate comprises a determination to exit processing of the classification model, and the method further comprises processing the first intermediate activation data with a first classifier of the plurality of classifiers to generate the classification result.

In some aspects of method 700, the determination by the first gate comprises a determination to continue processing of the classification model, and the method further comprises providing the first intermediate activation data to a second portion of the classification model.

In some aspects of method 700, processing the first intermediate activation data by the second portion of the classification model to generate second intermediate activation data; providing the second intermediate activation data to a second gate; and making a determination by the second gate whether or not to exit processing by the classification model.

Method 700 then proceeds to step 708 with generating a classification result from one of a plurality of classifiers of the classification model.

In some aspects of method 700, the input data comprises image data, and the classification model comprises an image classification model.

In some aspects of method 700, the first gate comprises a temporal comparison model configured to compare the first intermediate activation data from a current time step to previous intermediate activation data from a previous time step.

In some aspects of method 700, the determination by the first gate comprises a determination to exit processing of the classification model based on a similarity of the first intermediate activation data from the current time step to previous intermediate activation data from the previous time step, and the method further comprises outputting classification data from the previous time step from the classification model.

In some aspects of method 700, the determination by the first gate comprises a determination to continue processing by the classification model based on a dissimilarity of the first intermediate activation data from the current time step to previous intermediate activation data from the previous time step, and the method further comprises: providing the first intermediate activation data to a second gate configured to determine the complexity of the first intermediate activation data; making a determination by the second gate, based on the first intermediate activation data from the current time step, whether or not to exit processing by the classification model.

In some aspects of method 700, the determination by the second gate comprises a determination to exit processing of the classification model, and the method further comprises processing the first intermediate activation data with a first classifier of the plurality of classifiers to generate the classification result.

In some aspects of method 700, the second gate has been trained using a batch-shaping loss function to minimize classification error and to minimize processing resource usage.

In some aspects, method 700 further includes convolving the first intermediate activation data using one or more convolution layers prior to providing the first intermediate activation data to the first gate.

In some aspects of method 700, the input data comprises video data, and the classification model comprises a video classification model.

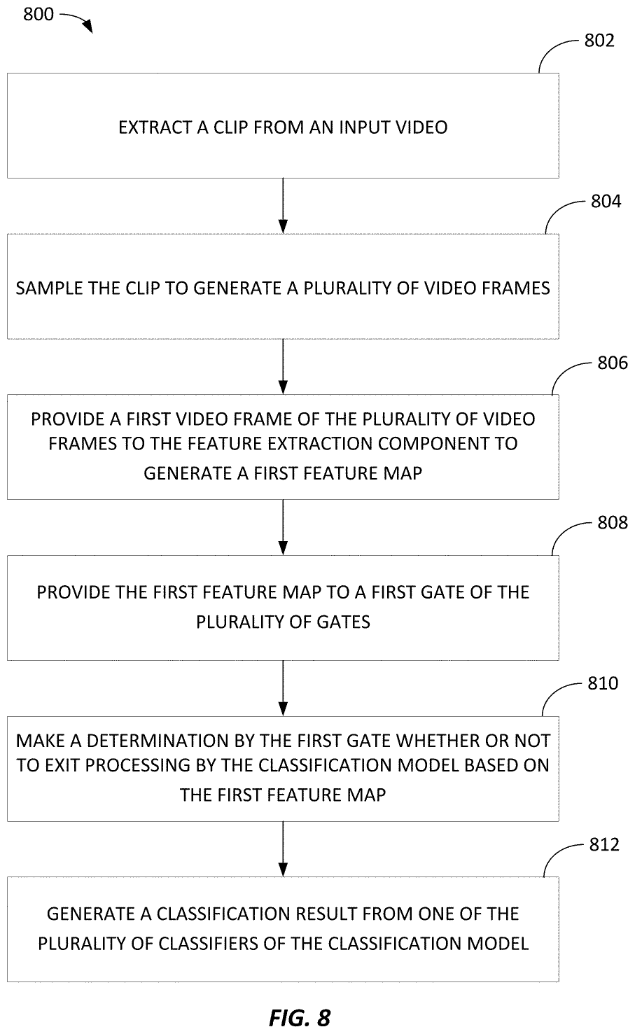

FIG. 8 depicts an example method for performing processing with an early exiting model architecture, such as that described above with respect to FIGS. 5-6.

Method 800 begins at step 802 with extracting a clip from an input video.

Method 800 then proceeds to step 804 with sampling the clip to generate a plurality of video frames. For example, the sampling may be performed according to a frame sampling policy, as described above.

Method 800 then proceeds to step 806 with providing a first video frame of the plurality of video frames to the feature extraction component to generate a first feature map.

Method 800 then proceeds to step 808 with providing the first feature map to a first gate of the plurality of gates.

Method 800 then proceeds to step 810 with making a determination by the first gate whether or not to exit processing by the classification model based on the first feature map.

Method 800 then proceeds to step 812 with generating a classification result from one of the plurality of classifiers of the classification model.

In some aspects of method 800, the classification model comprises: a feature extraction component; a feature aggregating component; a plurality of gates; and a plurality of classifiers, wherein each gate of the plurality of gates is associated with one classifier of the plurality of classifiers, as described above with respect to FIG. 5.

In some aspects of method 800, the determination by the first gate comprises a determination to exit processing of the classification model, and the method further comprises processing the first feature maps with a first classifier of the plurality of classifiers to generate the classification result, wherein each of the plurality of classifiers is associated with a model portion (e.g., model portions 104A-104C in FIG. 1), and wherein the classification model comprises a directional sequence of model portions (e.g., the sequence of model portions processed in FIG. 1 starts with model portion 104A and, if there is no early exit, proceeds through model portions 104B and 104C in a directional manner).

In some aspects of method 800, the determination by the first gate comprises a determination to continue processing of the classification model, and the method further comprises: providing a second video frame of the plurality of video frames to the feature extraction component to generate a second feature map; aggregating the first feature map with the second feature map using the feature aggregating component to generate an aggregated feature map; providing the aggregated feature map to a second gate of the plurality of gates; and making a determination by the second gate whether or not to exit processing by the classification model, wherein each of the plurality of classifiers is associated with a model portion, and wherein the classification model comprises a directional sequence of model portions.

In some aspects of method 800, aggregating the first feature map with the second feature map comprises performing a pooling operation on the first feature map and the second feature map by the feature aggregation component of the classification model.

In some aspects of method 800, the determination to exit processing of the classification model is based on a sufficient confidence of the first gate that a first classifier can classify the first feature map.

In some aspects of method 800, the determination to continue processing of the classification model is based on an insufficient confidence of the first gate that the first classifier can classify the first feature map.

In some aspects of method 800, the plurality of video frames comprises a temporally shuffled series of video frames.

In some aspects, method 800 further includes generating the temporally shuffled series of video frames via a policy function.

In some aspects of method 800, each gate of the plurality of gates comprises one or more neural network layers configured to generate the determination of whether or not to exit processing by the classification model, such as described above with respect to FIG. 6. In some aspects of method 800, the one or more neural network layers comprise a multi-layer perceptron layer.

### Example Processing System

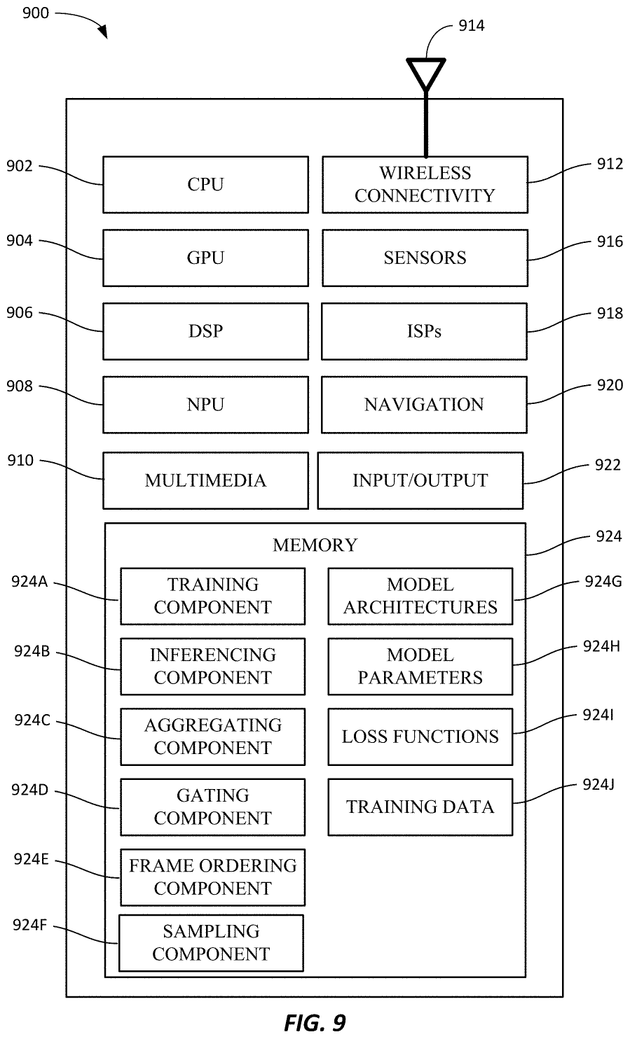

FIG. 9 depicts an example processing system 900 that may be configured to perform the methods described herein, such with respect to FIGS. 1-8.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition 924.

Processing system 900 also includes additional processing components tailored to specific functions, such as a graphics processing unit (GPU) 904, a digital signal processor (DSP) 906, a neural processing unit (NPU) 909, a multimedia processing unit 910, and a wireless connectivity component 912.

An NPU, such as 908, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 908, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In some aspects, NPU 908 may be implemented as a part of one or more of CPU 902, GPU 904, and/or DSP 906.

In some aspects, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned components of processing system 900.

In particular, in this example, memory 924 includes training component 924A, inferencing component 924B, aggregating component 924C, gating component 924D, frame ordering component 924E, sampling component 924F, model architectures 924G, model parameters 924H, loss functions 9241, and training data 924J. One or more of the depicted components, as well as others not depicted, may be configured to perform various aspects of the methods described herein.

Generally, processing system 900 and/or components thereof may be configured to perform the methods described herein.

Notably, in other aspects, aspects of processing system 900 may be omitted, such as where processing system 900 is a server. For example, multimedia component 910, wireless connectivity 912, sensors 916, ISPs 918, and/or navigation component 920 may be omitted in other aspects. Further, aspects of processing system 900 maybe distributed, such as training a model and using the model to generate inferences, such as user verification predictions.

Further, in other aspects, various aspects of methods described above may be performed on one or more processing systems.

### Example Clauses

Implementation examples are described in the following numbered clauses:

Clause 1: A method, comprising: processing input data in a first portion of a classification model to generate first intermediate activation data; providing the first intermediate activation data to a first gate; making a determination by the first gate whether or not to exit processing by the classification model; and generating a classification result from one of a plurality of classifiers of the classification model.

Clause 2: The method of Clause 1, wherein the first gate comprises: a pooling layer configured to reduce a dimensionality of the first intermediate activation data; one or more neural network layers configured to generate the determination of whether or not to exit processing by the classification model; and a Gumbel sampling component.

Clause 3: The method of Clause 2, wherein the one or more neural network layers comprise a plurality of multi-layer perceptron layers.

Clause 4: The method of any one of Clauses 1-3, wherein: the determination by the first gate comprises a determination to exit processing of the classification model, and the method further comprises processing the first intermediate activation data with a first classifier of the plurality of classifiers to generate the classification result, wherein each of the plurality of classifiers is associated with a model portion, and wherein the classification model comprises a directional sequence of model portions.

Clause 5: The method of any one of Clauses 1-3, wherein: the determination by the first gate comprises a determination to continue processing of the classification model, and the method further comprises providing the first intermediate activation data to a second portion of the classification model, wherein each of the plurality of classifiers is associated with a model portion, and wherein the classification model comprises a directional sequence of model portions.

Clause 6: The method of Clause 5, further comprising: processing the first intermediate activation data by the second portion of the classification model to generate second intermediate activation data; providing the second intermediate activation data to a second gate; and making a determination by the second gate whether or not to exit processing by the classification model, wherein each of the plurality of classifiers is associated with a model portion, and wherein the classification model comprises a directional sequence of model portions.

Clause 7: The method of any one of Clauses 1-6, wherein: the input data comprises image data, and the classification model comprises an image classification model.

Clause 8: The method of any one of Clauses 1-7, wherein the first gate has been trained using a batch-shaping loss function to minimize classification error and to minimize processing resource usage.

Clause 9: The method of Clause 1, wherein the first gate comprises a temporal comparison model configured to compare the first intermediate activation data from a current time step to previous intermediate activation data from a previous time step.

Clause 10: The method of Clause 9, wherein: the determination by the first gate comprises a determination to exit processing of the classification model based on a similarity of the first intermediate activation data from the current time step to previous intermediate activation data from the previous time step, and the method further comprises outputting classification data from the previous time step from the classification model.

Clause 11: The method of Clause 9, wherein: the determination by the first gate comprises a determination to continue processing by the classification model based on a dissimilarity of the first intermediate activation data from the current time step to previous intermediate activation data from the previous time step, and the method further comprises: providing the first intermediate activation data to a second gate configured to determine the complexity of the first intermediate activation data; making a determination by the second gate, based on the first intermediate activation data from the current time step, whether or not to exit processing by the classification model.

Clause 12: The method of Clause 11, wherein: the determination by the second gate comprises a determination to exit processing of the classification model, and the method further comprises processing the first intermediate activation data with a first classifier of the plurality of classifiers to generate the classification result.

Clause 13: The method of any one of Clauses 9-12, wherein the second gate has been trained using a batch-shaping loss function to minimize classification error and to minimize processing resource usage.

Clause 14: The method of and one of Clauses 1-13, further comprising convolving the first intermediate activation data using one or more convolution layers prior to providing the first intermediate activation data to the first gate.

Clause 15: The method of any one of Clauses 9-14, wherein: the input data comprises video data, and the classification model comprises a video classification model.

Clause 16: A method of performing classification with a classification model, wherein: the classification model comprises: a feature extraction component; a feature aggregating component; a plurality of gates; and a plurality of classifiers, wherein each gate of the plurality of gates is associated with one classifier of the plurality of classifiers, and the method comprises: extracting a clip from an input video; sampling the clip to generate a plurality of video frames; providing a first video frame of the plurality of video frames to the feature extraction component to generate a first feature map; providing the first feature map to a first gate of the plurality of gates; making a determination by the first gate whether or not to exit processing by the classification model based on the first feature map; and generating a classification result from one of the plurality of classifiers of the classification model.

Clause 17: The method of Clause 16, wherein: the determination by the first gate comprises a determination to exit processing of the classification model, and the method further comprises processing the first feature maps with a first classifier of the plurality of classifiers to generate the classification result.

Clause 18: The method of any one of Clauses 16-17, wherein: the determination by the first gate comprises a determination to continue processing of the classification model, and the method further comprises: providing a second video frame of the plurality of video frames to the feature extraction component to generate a second feature map; aggregating the first feature map with the second feature map using the feature aggregating component to generate an aggregated feature map; providing the aggregated feature map to a second gate of the plurality of gates; and making a determination by the second gate whether or not to exit processing by the classification model.

Clause 19: The method of any one of Clauses 16-18, wherein aggregating the first feature map with the second feature map comprises performing a pooling operation on the first feature map and the second feature map by the feature aggregation component of the classification model.

Clause 20: The method of Clause 17, wherein the determination to exit processing of the classification model is based on a sufficient confidence of the first gate that a first classifier can classify the first feature map.

Clause 21: The method of Clause 18, wherein the determination to continue processing of the classification model is based on an insufficient confidence of the first gate that the first classifier can classify the first feature map.

Clause 22: The method of any one of Clauses 16-21, wherein the plurality of video frames comprises a temporally shuffled series of video frames.

Clause 23: The method of Clauses 22, further comprising generating the temporally shuffled series of video frames via a policy function.

Clause 24: The method of any one of Clauses 16-23, wherein each gate of the plurality of gates comprises one or more neural network layers configured to generate the determination of whether or not to exit processing by the classification model.

Clause 25: The method of Clause 24 wherein the one or more neural network layers comprise a multi-layer perceptron layer.

Clause 26: A processing system, comprising: a memory comprising computer-executable instructions; and a processor configured to execute the computer-executable instructions and cause the processing system to perform a method in accordance with any one of Clauses 1-25.

Clause 27: A non-transitory computer-readable medium comprising computer-executable instructions that, when executed by a processor of a processing system, cause the processing system to perform a method in accordance with any one of Clauses 1-25.

Clause 28: A computer program product embodied on a computer readable storage medium comprising code for performing a method in accordance with any one of Clauses 1-25.

Clause 29: A processing system, comprising means for performing a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
processing input data in a first portion of a classification model to generate first intermediate activation data;
providing the first intermediate activation data to a first gate;
making a determination by the first gate whether or not to exit processing by the classification model; and
generating a classification result from one of a plurality of classifiers of the classification model.

2. The method of claim 1, wherein the first gate comprises:
a pooling layer configured to reduce a dimensionality of the first intermediate activation data;
one or more neural network layers configured to generate the determination of whether or not to exit processing by the classification model; and
a Gumbel sampling component.

3. The method of claim 2, wherein the one or more neural network layers comprise a plurality of multi-layer perceptron layers.

4. The method of claim 1, wherein:
the determination by the first gate comprises a determination to exit processing of the classification model, and
the method further comprises processing the first intermediate activation data with a first classifier of the plurality of classifiers to generate the classification result,
wherein each of the plurality of classifiers is associated with a model portion, and
wherein the classification model comprises a directional sequence of model portions.

5. The method of claim 1, wherein:
the determination by the first gate comprises a determination to continue processing of the classification model, and
the method further comprises providing the first intermediate activation data to a second portion of the classification model,
wherein each of the plurality of classifiers is associated with a model portion, and
wherein the classification model comprises a directional sequence of model portions.

6. The method of claim 5, further comprising:
processing the first intermediate activation data by the second portion of the classification model to generate second intermediate activation data;
providing the second intermediate activation data to a second gate; and
making a determination by the second gate whether or not to exit processing by the classification model,
wherein each of the plurality of classifiers is associated with a model portion, and
wherein the classification model comprises a directional sequence of model portions.

7. The method of claim 1, wherein:
the input data comprises image data, and
the classification model comprises an image classification model.

8. The method of claim 1, wherein the first gate has been trained using a batch-shaping loss function to minimize classification error and to minimize processing resource usage.

9. The method of claim 1, wherein the first gate comprises a temporal comparison model configured to compare the first intermediate activation data from a current time step to previous intermediate activation data from a previous time step.

10. The method of claim 9, wherein:
the determination by the first gate comprises a determination to exit processing of the classification model based on a similarity of the first intermediate activation data from the current time step to previous intermediate activation data from the previous time step, and
the method further comprises outputting classification data from the previous time step from the classification model.

11. The method of claim 9, wherein:
the determination by the first gate comprises a determination to continue processing by the classification model based on a dissimilarity of the first intermediate activation data from the current time step to previous intermediate activation data from the previous time step, and
the method further comprises:
providing the first intermediate activation data to a second gate configured to determine a complexity of the first intermediate activation data; and
making a determination by the second gate, based on the first intermediate activation data from the current time step, whether or not to exit processing by the classification model.

12. The method of claim 11, wherein:
the determination by the second gate comprises a determination to exit processing of the classification model, and
the method further comprises processing the first intermediate activation data with a first classifier of the plurality of classifiers to generate the classification result.

13. The method of claim 1, further comprising convolving the first intermediate activation data using one or more convolution layers prior to providing the first intermediate activation data to the first gate.

14. The method of claim 9, wherein:
the input data comprises video data, and
the classification model comprises a video classification model.

15. A processing system, comprising:
a memory comprising computer-executable instructions; and
a processor configured to execute the computer-executable instructions and cause the processing system to:
process input data in a first portion of a classification model to generate first intermediate activation data;
provide the first intermediate activation data to a first gate;
make a determination by the first gate whether or not to exit processing by the classification model; and
generate a classification result from one of a plurality of classifiers of the classification model.

16. The processing system of claim 15, wherein the first gate comprises:
a pooling layer configured to reduce a dimensionality of the first intermediate activation data;
one or more neural network layers configured to generate the determination of whether or not to exit processing by the classification model; and
a Gumbel sampling component.

17. The processing system of claim 16, wherein the one or more neural network layers comprise a plurality of multi-layer perceptron layers.

18. The processing system of claim 15, wherein:
the determination by the first gate comprises a determination to exit processing of the classification model, and
the processor is further configured to cause the processing system to process the first intermediate activation data with a first classifier of the plurality of classifiers to generate the classification result,
wherein each of the plurality of classifiers is associated with a model portion, and
wherein the classification model comprises a directional sequence of model portions.

19. The processing system of claim 15, wherein:
the determination by the first gate comprises a determination to continue processing of the classification model, and
the processor is further configured to cause the processing system to provide the first intermediate activation data to a second portion of the classification model,
wherein each of the plurality of classifiers is associated with a model portion, and
wherein the classification model comprises a directional sequence of model portions.

20. The processing system of claim 19, wherein the processor is further configured to cause the processing system to:
process the first intermediate activation data by the second portion of the classification model to generate second intermediate activation data;
provide the second intermediate activation data to a second gate; and
make a determination by the second gate whether or not to exit processing by the classification model,
wherein each of the plurality of classifiers is associated with a model portion, and
wherein the classification model comprises a directional sequence of model portions.

21. The processing system of claim 15, wherein:
the input data comprises image data, and
the classification model comprises an image classification model.

22. The processing system of claim 15, wherein the first gate has been trained using a batch-shaping loss function to minimize classification error and to minimize processing resource usage.

23. The processing system of claim 15, wherein the first gate comprises a temporal comparison model configured to compare the first intermediate activation data from a current time step to previous intermediate activation data from a previous time step.

24. The processing system of claim 23, wherein:
the determination by the first gate comprises a determination to exit processing of the classification model based on a similarity of the first intermediate activation data from the current time step to previous intermediate activation data from the previous time step, and
the processor is further configured to cause the processing system to output classification data from the previous time step from the classification model.

25. The processing system of claim 23, wherein:
the determination by the first gate comprises a determination to continue processing by the classification model based on a dissimilarity of the first intermediate activation data from the current time step to previous intermediate activation data from the previous time step, and
the processor is further configured to cause the processing system to:
provide the first intermediate activation data to a second gate configured to determine a complexity of the first intermediate activation data; and
make a determination by the second gate, based on the first intermediate activation data from the current time step, whether or not to exit processing by the classification model.

26. The processing system of claim 25, wherein:
the determination by the second gate comprises a determination to exit processing of the classification model, and
the processor is further configured to cause the processing system to process the first intermediate activation data with a first classifier of the plurality of classifiers to generate the classification result.

27. The processing system of claim 15, wherein the processor is further configured to cause the processing system to convolve the first intermediate activation data using one or more convolution layers prior to providing the first intermediate activation data to the first gate.

28. The processing system of claim 23, wherein:
the input data comprises video data, and
the classification model comprises a video classification model.

29. A non-transitory computer-readable medium comprising computer-executable instructions that, when executed by a processor of a processing system, cause the processing system to perform a method, the method comprising:
processing input data in a first portion of a classification model to generate first intermediate activation data;
providing the first intermediate activation data to a first gate;
making a determination by the first gate whether or not to exit processing by the classification model; and
generating a classification result from one of a plurality of classifiers of the classification model.

30. A processing system, comprising:
means for processing input data in a first portion of a classification model to generate first intermediate activation data;
means for providing the first intermediate activation data to a first gate;
means for making a determination by the first gate whether or not to exit processing by the classification model; and
means for generating a classification result from one of a plurality of classifiers of the classification model.
